(19) United States
(12) Patent Application Publication
(10) Pub. No.: US 2016/0338000 A1
(43) Pub. Date: Nov. 17, 2016

(54) IDENTIFICATION TAG FOR TRACKING OBJECTS

(71) Applicants: Brian L. HALLA, Saratoga, CA (US); Nick R. COLONNA, Granite Bay, CA (US)

(72) Inventors: Brian L. HALLA, Saratoga, CA (US); Nick R. COLONNA, Granite Bay, CA (US)

(21) Appl. No.: 14/714,025

(22) Filed: May 15, 2015

(51) Int. Cl. H04W 64/00

(52) U.S. Cl. CPC H04W 64/00; H04W 84/12

(57) ABSTRACT

An apparatus for location of objects is provided. The apparatus includes an integrated circuit including a processor, a memory, a transceiver for sending and receiving data over a cellular network, and GPS receiver components for receiving GPS signals. The apparatus further includes an outer housing which may be operatively affixed to an object. Responsive to a notification over the cellular network from a subscriber, the apparatus determines location information and transmits the location information to the subscriber. In one embodiment, the apparatus is powered by a MEMS power source configured to harvest mechanical energy for conversion to electrical energy.

### BACKGROUND

1. Field

The present disclosure relates generally to communication systems, and more particularly, to an apparatus for locating objects via wireless networks.

2. Background

Cellular communication systems are widely deployed to provide various telecommunication services such as telephony, video, data, messaging, and broadcasts. Typical cellular communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The “Internet of Things” (IOT) is a marketing term describing the network of objects embedded with electronics, software, and connectivity to enable greater access to and value from such objects. TOT has not conventionally been realized, because for many applications the “things”, to be accessible, must be located in a hot spot or WiFi area. That is, the “things” must be at least as accessible as a person's cell phone at any given point in time or location. This is equally true for the available devices in the market for monitoring or locating objects.

Various wireless devices for tracking items such as vehicles, persons and animals have been implemented or proposed in the literature. One such device includes a location monitoring apparatus that may be affixed to an item to be tracked, e.g., as part of a dog collar. The apparatus is designed to work with an IEEE 802.11 WiFi network to send a wireless transmission over the internet to a recipient, where the transmission includes location information. Such a device lacks utility when either an appropriate WiFi network is unavailable or is encrypted, or more generally, when the device is out of range or otherwise unable to access such a network.

Another device used for tracking purposes provides functionality for providing location information and conveys information via a Global System for Mobile Communications (GSM) network. Among other shortcomings, this device has a large form factor, which renders the device inappropriate for use to monitor potentially stolen items where the inconspicuous nature of the tracking device becomes an important consideration. In addition, these devices have high power demands and need to be recharged often. Further, the devices are expensive even when they are not used, since a monthly subscription fee is assessed for each such device. As a result, these devices are impractical for a variety of applications such as locating missing pets or livestock, or for stolen items that have been missing for more than a few days.

As another illustration, LoJack Recovery System is a radio transceiver that is typically installed in a vehicle. The device and the vehicle's VIN are registered in a database which interfaces with the National Crime Information Center (NCIC) system used by law enforcement agencies. If the car is stolen, a customer reports the incident to the police, who enter the stolen vehicle's VIN into the state police crime computer. Specialized LoJack computers trigger a remote command to the LoJack unit to transmit signals to tracking units aboard police cars within a certain radius of the signal source. The tracking units will display information identifying the vehicle as well as its approximate direction and distance to the stolen vehicle. LoJack transmits on a radio (RF) carrier frequency of 173.075 MHz.

Lojack requires the use of a specialized national database, specialized computers using a special frequency, as well as a phased array of antennas placed on a vehicle. Because Lojack is implemented on specialized computers using a dedicated network, this technology is not suitable for ubiquitous use by consumers.

In addition, for applications requiring a small form factor, such as, for example, where the tracking device is to be attached to small dogs or modestly-sized valuables (e.g., paintings), current devices are too large to accommodate these types of applications. This larger size is often due to the need for powering the device in a practical manner, which typically requires an independent power source or a large enough battery to enable the device to be applicable to practical situations.

These and other shortcomings are addressed in the present application.

### SUMMARY

In an aspect of the disclosure, a method, a computer program product, and an apparatus are provided. The apparatus includes a housing, and an integrated circuit arranged in the housing and including a transceiver configured to receive, over a cellular network, a notification for tracking an object to which the housing is operatively affixed, and a processor coupled to the transceiver and configured to determine, responsive to the notification, information characterizing a location of the object, wherein the transceiver is further configured to transmit the information over the cellular network to a source node.

In another aspect of the disclosure, an apparatus includes an integrated circuit, a housing encasing at least a portion of the integrated circuit therein, an outer surface of the member affixed via an attachment medium to an object, wherein the integrated circuit includes a transceiver configured to receive, over a cellular network, a notification, and a processor coupled to the transceiver and configured to provide, after receiving the notification, information characterizing a location of the object, wherein the transceiver is further configured to transmit the information to a source node for use in locating the object.

In another aspect of the disclosure, the apparatus includes a power source including a Micro-Electro-Mechanical Systems (MEMS) device configured to harvest kinetic energy from mechanical movement or vibrations.

In another aspect of the disclosure, an integrated circuit device includes an integrated circuit, and a packaging substantially encasing the integrated circuit, an external surface of the packaging operatively affixed via an attachment medium to an object to be monitored, wherein the integrated circuit comprises a processing system configured to receive a notification over a cellular network, provide, responsive to the notification, information for identifying a location of the object, and transmit the information over the cellular network to a source node.

In another aspect of the disclosure, a method includes receiving, over a cellular network, a notification for tracking a thing to which an integrated circuit device is operatively affixed, providing, responsive to the notification, information corresponding to a location of the thing, and transmitting the information over the cellular network to a source node.

In another aspect of the disclosure, a computer program product comprising a non-transitory computer readable medium having executable code for receiving, over a cellular network, a notification for tracking a thing to which an integrated circuit device is operatively affixed, providing, responsive to the notification, information corresponding to a location of the thing, and transmitting the information over the cellular network to a source node.

### BRIEF DESCRIPTION OF THE DRAWINGS

FIG. 1 is a block diagram of an apparatus for locating objects.

FIG. 2 is a diagram illustrating an example of an access network.

FIG. 3A is a flow diagram illustrating a method for locating an object.

FIG. 3B is a flow diagram illustrating a method for locating an object.

FIG. 4 is a diagram illustrating methods for locating an object.

FIG. 5 is a flow diagram of a method for locating an object.

FIG. 6A is an illustration of an exemplary apparatus for locating objects.

FIG. 6B is an illustration of side views of the apparatus for locating objects.

FIG. 6C is an illustration of a perspective view of the apparatus showing an integrated circuit embedded within the apparatus.

FIG. 7 illustrates a perspective view of the apparatus and the integrated circuit, and an exemplary layout of functional blocks therein.

FIG. 8 is an illustration of an apparatus for locating objects affixed to a pet collar via a clamp mechanism.

FIG. 9 is an illustration of an apparatus affixed to a computer monitor and a painting.

### DETAILED DESCRIPTION

The detailed description set forth below in connection with the appended drawings is intended as a description of various configurations and is not intended to represent the configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. In some embodiments, the term “processor” may be used to refer to two or more individual processors.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), compact disk ROM (CD-ROM) or other optical disk storage, magnetic disk storage or other magnetic storage devices, combinations of the aforementioned types of computer-readable media, or any other medium that can be used to store computer executable code in the form of instructions or data structures that can be accessed by a computer.

For purposes of this disclosure, objects to be located or tracked may include physical items such as electronic devices, vehicles, paintings, antiques, valuables, and the like, or persons or animals. An apparatus for locating objects is referred to herein for convenience, from time to time, as a tag or an IOTAG. Additionally, the term cellular network refers generally to a wireless network distributed over geographical areas referred to as cells, where each cell is served by at least one fixed-location transceiver or base station. Examples of cellular networks include LTE, GSM, CDMA, CDMA-2000, W-CDMA, and the like. The term cellular technology refers to the circuit implementation used to realize communications over a cellular network.

A basic digital cell phone typically includes a circuit board containing the phone's processing hardware, an antenna, a liquid crystal display (LCD), a keypad, a microphone, a speaker, and a battery. For purposes of an electronic identification tag according to certain embodiments, certain of these parts need not be included as part of the tag. For instance, in some embodiments, the tag may not require a speaker, a microphone, a keyboard or a display. In these embodiments, the tag instead may use just an antenna and the portions of the circuit board that give it the ability to detect a call or other notification over a cellular network a GPS receiver to calculate its location (such as via GPS coordinates or another mobile tracking method) and to return those coordinates to the caller, a corresponding power source. In this manner, the integrated circuit may be greatly simplified, the components may be assembled onto a single die, and the overall form factor may be reduced.

In one aspect of the disclosure, a single chip semiconductor circuit provides the above component blocks, which includes at least enough of the cell phone capability to know a call to that circuit has been made and the GPS capability to determine a location based information based on GPS signals transmitted from satellites. The circuit may triangulate its location from three or four satellites and return location information including its GPS coordinates to the cell on which it is camped for transmission back to the caller. Alternatively, the circuit may provide location information sufficient for the network to determine the circuit's estimated location relative to one or more cells. The integrated circuit may provide periodic transmissions to the cell to enable the cell to identify the circuit.

Because the circuit is integrated and contains a minimum number of components, the circuit can be manufactured at a low cost relative to more sophisticated cellular devices. In one embodiment, the service providers or wireless carriers may procure and issue such integrated circuits and corresponding cell phone numbers and make them available for a nominal, if any, charge to a subscriber. In one model, the service provider would be compensated in the event a call is subsequently made by a subscriber to retrieve a missing object.

In this scenario, the tag might only be accessed (e.g., called) in emergencies such as a missing pet, a stolen car, a missing child or stolen art, A/V equipment or jewelry, and the like. This model provides an attractive up front option in that subscribers may obtain the device cheaply, and unless and until the device is used there is little or no cost to the subscriber. Additionally, until the device is used there would be very limited use of bandwidth (e.g., limited to cell registration or beacon signals between the tag and the network) and thus limited associated costs to the service provider.

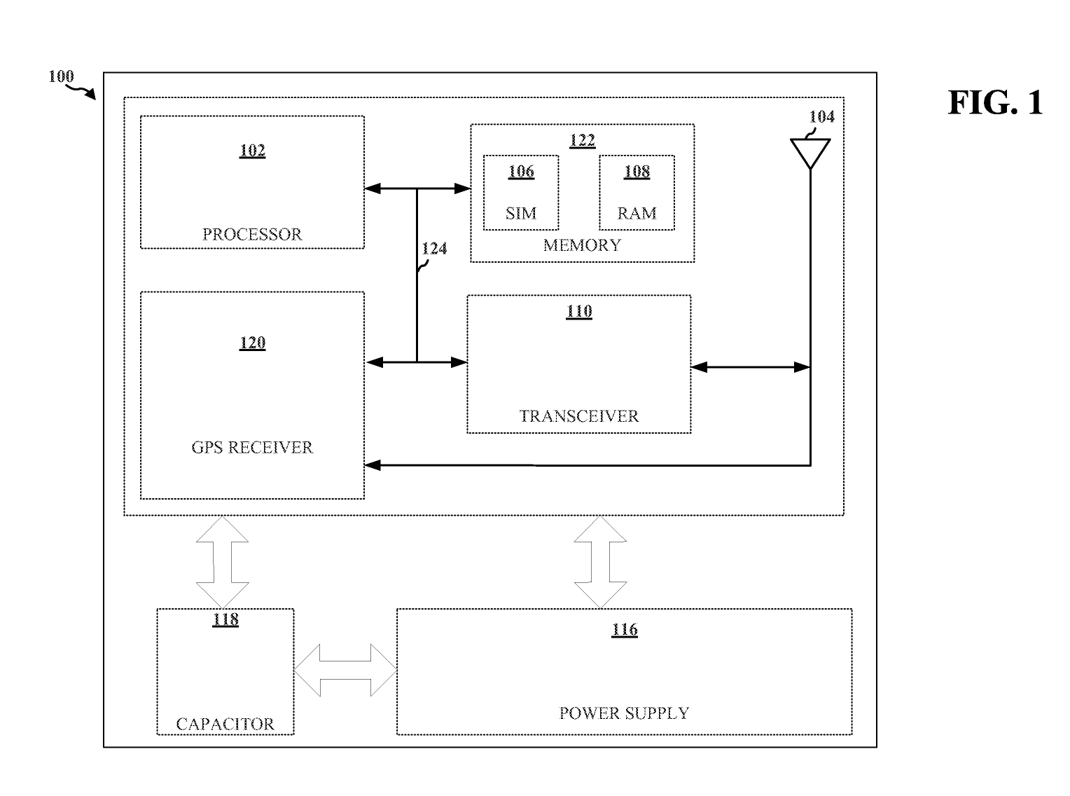

FIG. 1 is a block diagram illustrating an IOTAG or an apparatus 100 for locating objects. The apparatus may be an integrated circuit. In one embodiment, the components of the apparatus are disposed on the same die. In other embodiments, the components of the apparatus may be distributed on two or more die arranged in proximity to one another so as to effect a compact structure. Apparatus 100 includes processor 102, memory 122, GPS receiver 120, transceiver 110, antenna 104, power supply 116 and capacitor 118. Memory 122 may include subscriber identity module (SIM) 106 to store a subscriber profile, a cellular phone number, an international mobile subscriber identity (IMSI) and the related key used to identify and authenticate a subscriber. In one configuration, the SIM operates as an ISO/IEC 7816-3 class C device at a voltage of 1.8 V. The SIM may be integrated with other components or it may stand alone as a separate component.

Memory 108 may include random access memory, flash memory, cache memory, or some combination thereof. In some embodiments, cache memory is additionally or alternatively included as a component of the processor 102.

GPS receiver 120 may include a processor and a stable crystal oscillator. Transceiver 110 may include a transmitter and a receiver suitable for sending and receiving data over one or more cellular networks. In some embodiments, transceiver 110 may also include signal recovery circuitry for receiving GPS satellite signals. In other embodiments, the GPS signal recovery circuitry may be included in GPS receiver 120. GPS receiver 120 may relay position data using any known protocol, such as the National Marine Electronics Association (NMEA) 0183 protocol, the SiRF protocol, the MTK protocol, and the like. GPS receiver 120 can interface with other devices via transceiver 110 and antenna 104 as described below.

Processor 102, memory 122, GPS receiver 120 and transceiver 110 may be electrically coupled via bus 124. Antenna 104 is electrically coupled to transceiver 110 and GPS receiver 120. In some embodiments, GPS satellite signals may be received via antenna 104 and transceiver 110. In other embodiments, GPS receiver 120 may use a separate antenna or antenna array.

Generally, processor 102, memory 122 and transceiver 110 are designed to be compatible with at least one cellular technology. In one embodiment, processor 102 is compatible with both 3G and 4G technologies, making it a dual-mode device. In one such dual-mode embodiment, the apparatus 100 is configured to communicate wireless data on both LTE and CDMA networks. The precise type of dual mode may vary depending on the network infrastructure in a subscriber's region. In other embodiments the apparatus 100 may be configured with processing circuitry for enabling compatibility with one or more short-range networks including WiFi and Bluetooth in addition to the cellular radio. These latter network types may be used in various embodiments when they are detected, available, and are either unencrypted or the encryption key is known and when communication via the cellular network is unnecessary.

In some embodiments, processor 102 may be a “paired down” version of an existing processor on a conventional mobile handset. For example, processor 102 may include a single core that excludes graphics and audio processing circuitry, or it may have minimal features dedicated to these functions. Additionally, the processor architecture may be simplified relative to other cellular devices such as conventional cellular handsets. In an embodiment, processor 102 and GPS receiver 120 are integrated into a single component.

Transceiver 110 may include one or more transmitters and receivers for sending and receiving cellular signals to and from a network via antenna 104. For example, transceiver may include GPS receiver front end circuitry for receiving and processing GPS signals received from satellites, and a transmitter/receiver pair for transmitting and receiving the cellular signals. Transceiver 110 may include the necessary modulators, demodulators, amplifiers and filters for transmitting and receiving these signals.

Antenna 104 may include an antenna array for wirelessly communicating data to and from the cellular network. A separate antenna or array may be used to receive GPS signals as noted above. Antenna 104 may be designed to be compatible with the requirements of the associated wireless carrier (such as AT&T, Verizon, Orange, China Mobile, etc.) as well as the applicable regulatory requirements (such as from the FCC). For example, wireless carriers typically set minimum specifications for the amount of total radiated power (TRP) for every frequency band the phone will support. Antenna 104 may include a primary cellular antenna which operates at frequencies specified by the applicable cellular standard. Most existing cellular devices support some combination of the following frequency bands/ranges:
GSM (2G)—GSM850 (824-894 MHz), GSM900 (890-960 MHz), DCS (1710-1880 MHz), PCS (1850-1990 MHz)
UMTS (3G)—Band 5 (824-894 MHz), Band 8 (890-960 MHz), Band 4 (1710-1880 MHz), Band 2 (1850-1990 MHz), Band 1 (1922-2170 MHz)
LTE (4G)—Band 17 (704-746 MHz), Band 13 (746-790 MHz), Band 5, Band 8, Band 4, Band 2, Band 1, Band 7 (2500-2690 MHz)

The size of the antenna array can be minimized in view of the fact that many of the bands overlap. For instance, GSM850, UMTS Band 5 and LTE Band 5 are all the same frequency range. Hence, an antenna that works well for one of these bands will largely work well for the other bands. Using this principle, the number of antennas in the array can be reduced to the smallest size necessary for the application. The antenna may be displaced about the perimeter of the apparatus to increase signal quality. In some embodiments, a fold-out antenna may be used. In other embodiments, the housing may include a conductor which acts as at least a portion of the antenna.

Apparatus 100 further includes power supply 116 and capacitor 118. As described further below, power supply 116 may include one of a number of suitable power sources geared toward the application. In one embodiment described further below, power supply 116 includes a MEMS circuit configured to harvest mechanical energy. Capacitor 118, which is coupled to power supply 116, may be used to store electrical energy when power from power supply 116 is interrupted or otherwise becomes unavailable. In one embodiment, to minimize the size of apparatus 100, power supply 116 and capacitor 118 are disposed on the same die as the remaining components of apparatus 100. In other embodiments, power supply 116 and/or capacitor 118 may be on a separate die or in a different package.

By integrating the above components of apparatus 100 in FIG. 1 in a single integrated circuit, as is characteristic of one embodiment, the form factor of the resulting apparatus can advantageously be made very small. Further, where all of the principal logic and processing circuits of apparatus 100 are contained in a single die, the average power consumption is rendered smaller than would be typical if several discrete components were used instead of the integrated circuit.

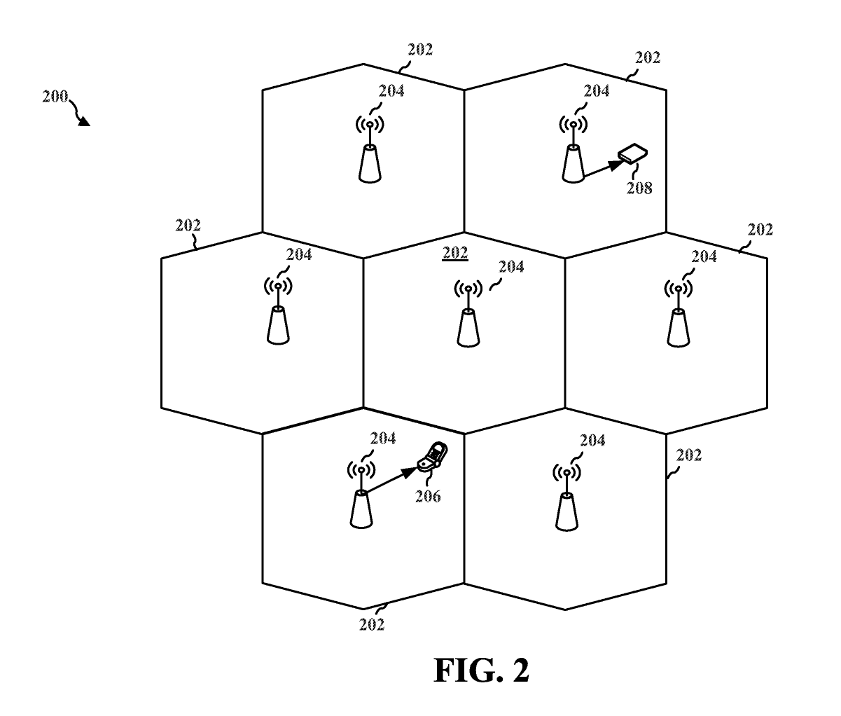

FIG. 2 is a diagram illustrating an example of an access network 200 in an illustrative LTE network architecture. In this example, the access network 200 is divided into a number of cellular regions (cells) 202. The base stations or eNBs 204 are each assigned to a respective cell 202 and are configured to provide an access point to an evolved packet core for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to a serving gateway. An eNB may support one or multiple (e.g., three) cells (also referred to as a sectors). The term “cell” can refer to the smallest coverage area of a base station, eNB and/or an eNB subsystem serving a particular coverage area. Further, the terms “eNB” and “base station,” may be used interchangeably herein.

The modulation and multiple access scheme employed by the access network 200 may vary depending on the particular telecommunications standard being deployed. In LTE applications, OFDM is used on the downlink channels and SC-FDMA is used on the uplink channels to support both frequency division duplex (FDD) and time division duplex (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

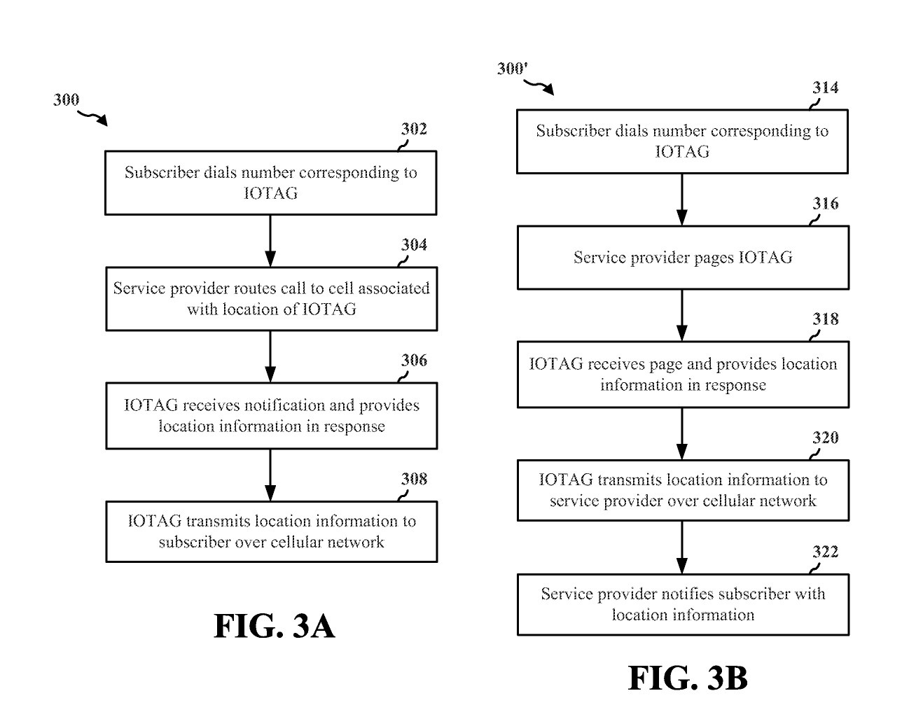

FIG. 3A is a flow diagram 300 illustrating a method for locating an object. An integrated circuit in an appropriate housing, referred to herein as an IOTAG, is affixed to an object to be located. In one embodiment, the IOTAG was provided by a wireless carrier as part of a subscription. One or more IOTAGs may have been provided to the subscriber free of charge or for a nominal fee. Thereupon, the subscriber may have affixed the IOTAG to various valuables (e.g., paintings, antiques, vases), pets, or other items. When the object to which the IOTAG is attached goes missing, the subscriber, per the instructions of the wireless carrier, dials a number corresponding to the IOTAG (302). This number may be the cellular number of the IOTAG. The call is routed by the wireless carrier or service provider to the cell associated with the location of the IOTAG (304), and the base station sends the call to the IOTAG. It is assumed that the IOTAG has been transmitting periodic messages or beacons to the base station associated with the cell in a manner known in the art, to enable the network to identify the IOTAG. When the IOTAG receives the call, it provides information characterizing its location as described below (306). Thereupon, the IOTAG transmits the location information to the subscriber using the cellular network (308).

Because the cellular networks generally have widespread coverage, the object may be tracked over a wide possible range.

FIG. 3B is a flow diagram 300′ illustrating a method for locating an object. As in FIG. 3A, a subscriber dials a number corresponding to the IOTAG (314). The service provider pages the IOTAG over the cellular network (316). The IOTAG receives the page and provides, for transmission over the cellular network, information corresponding to its location (318). The IOTAG transmits the location information to the service provider via the cellular network (320). The service provider notifies the subscriber with the location information (322), such as via a voice call, text, or over an IP network via a message to an application at the subscriber location or an e-mail to the subscriber.

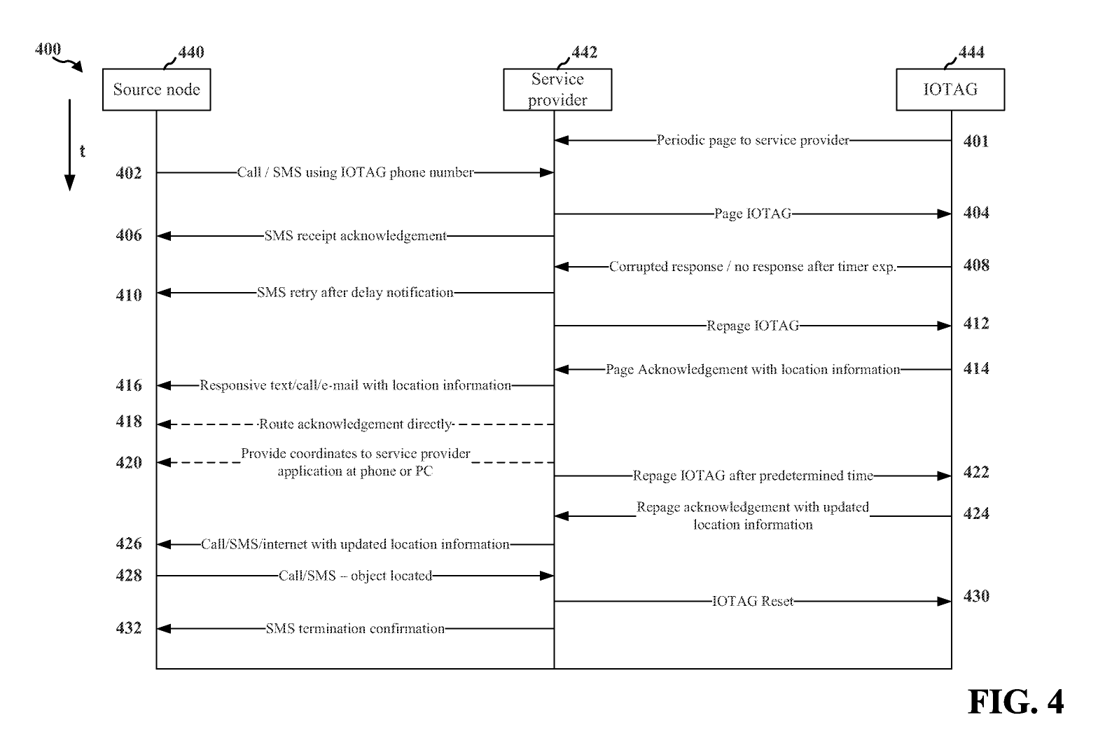

FIG. 4 is a diagram 400 illustrating methods for locating an object. The methods include use of a source node 440, a service provider 442 and an identification tag (IOTAG) 444. IOTAG 444 may include an integrated circuit encased in a housing for attachment to an object to be located. Source node 440 may include a cellular handset or similar device. Service provider 442 may be a wireless carrier such as Verizon, AT&T, Sprint, T-Mobile, and the like.

In this example, a subscriber using source node 440 has wireless service from service provider 442. Pursuant to an added feature or subscription, service provider 442 provides an IOTAG 444 to the subscriber for use in monitoring an object. In one embodiment, the IOTAG 444 is intended for use in emergency situations, similar to those described above (for example, when a pet goes missing, a valuable painting is stolen, livestock goes astray, etc.) Service provider 442 has associated a telephone number with IOTAG 444 and has programmed the SIM in IOTAG 444 accordingly. Pursuant to an illustrative business model, service provider 442 provides IOTAG 444 and the associated cellular number to the subscriber at a discounted price or for free. Thereupon, service provider 442 assesses a fee only when the subscriber has to dial the number to retrieve the object being monitored. For example, service provider 442 may charge $100 for the subscriber to call and receive location information and updates, as described below.

IOTAG 444 registers with the network and provides periodic transmissions or pages to the base station associated with the cell on which it is camped, and hence to service provider 442, to enable service provider to identify IOTAG 444 and determine its serving cell (401). In the example where IOTAG 444 has been affixed to a dog collar and the dog has wandered off, the handset subscriber at source node 440 calls the IOTAG cellular number (402). In some embodiments, the service may be configured such that the subscriber sends a text message to the number associated with IOTAG 444. Alternatively, the subscriber may call or text a number of the service provider or an affiliate that service provider 442 has allocated duties for assisting the subscriber in locating the object. In some embodiments, the transmission from source node 440 may be from another device such as a personal computer (PC) and the transfer mechanism may be an e-mail or similar message over IP, provided that service provider 442 has cellular connectivity to IOTAG 444. The cellular connectivity may be via a single cellular network (e.g., a 4G network) or through another cellular network through which IOTAG 444 is roaming, provided that IOTAG 444 is configured with a dual-mode capability to send and receive wireless communications through the other network. In another alternative embodiment, if a short-range network (e.g., an IEEE 802.11 network) is available and unencrypted and IOTAG 444 is so equipped with WiFi capability in addition to its cellular capabilities for receiving a message from source node 440 and/or service provider 444 or its affiliate, IOTAG 444 may provide responsive wireless communications via the short-range network.

In response to the call from source node 440 to IOTAG 444, service provider either routes the call to IOTAG 444 or, upon receipt of the call from the subscriber, pages IOTAG 444 (404). The page or call to IOTAG 444 is construed by the software and circuitry of IOTAG 444 to initiate a determination of location information in a manner to be further described below. Service provider 442 may send an SMS or other message to source node 440 providing, for example, an acknowledgment that service provider 442 has received the call from the subscriber and has initiated the process of identifying a location for the object (406).

In the event that no response is received after a predetermined time or upon expiration of a timer set by the network after paging IOTAG 444 (408), service provider 442 may notify source node 440 via an SMS message that no response has yet been received from IOTAG 444 and that service provider 442 will retry IOTAG 444, e.g., in a specified time period (410). At which point, service provider 442 may send another page to IOTAG 444 (412). When IOTAG 444 receives the message from the network via steps 404 or 412, IOTAG 444 determines information corresponding to its current location. This determination is made using a suitable mobile tracking technique. In one embodiment, for precision, IOTAG 444 has a GPS receiver and computes location coordinates for transmission to source node 440. IOTAG 444 responds, e.g., with a page acknowledgement containing these coordinates (or other location information as described herein) to service provider 442 (414). The location information may then be conveyed via a responsive text, call or e-mail to source node 440 (416). In one embodiment, IOTAG 444 calls source node 440 over the cellular network, or otherwise routes the information to source node 440 via the cellular network, to provide this information or a link thereto, e.g., in the form of a voice message (418). The link may be a URL address associated with the service provider. In other embodiments, the information is sent via text to source node 440. Alternatively, the information is transmitted over the cellular network to service provider 442, which in turn sends an e-mail to an e-mail address associated with source node 440 with the location information. In other configurations, service provider 442 may send the location information to an application located at or corresponding to source node 440, and the application provides a map and/or directions for locating the object associated with IOTAG 444 (420).

IOTAG 444 may itself be mobile, such as where IOTAG 444 is affixed to a pet or a painting in the cab of a moving truck. Accordingly, in one embodiment, service provider 442 may re-page IOTAG 444 after a predetermined time (422). In response to the page, IOTAG 444 may determine or compute updated coordinates or other location information and send an acknowledgment with updated location information over the cellular network to service provider 442 (424). The updated location information, in turn, may be provided to source node 440 in a manner described above relative to the initial location information (426).

Once the missing object is located, in one implementation, the subscriber may call or text service provider 442, or otherwise contact the service provider (e.g., via a link in an application or by e-mail) indicating that the object has been successfully retrieved (428). Thereupon, service provider 442 may issue a page to IOTAG 444 which causes the IOTAG to reset to its initial state (440). Alternatively, IOTAG 444 may reset itself after a prescribed time. Upon receiving the indication that the object has been located, service provider 442 may provide a confirmation back to source node 440 (432). The confirmation may include billing information corresponding to the session.

The location information may be determined in various ways, and may be network based, IOTAG based, or some combination thereof. In one embodiment, GPS or Assisted-GPS may be used. A GPS receiver is integrated with the circuit, and triangulates the location of the IOTAG upon receipt of satellite signals. In this manner, the IOTAG is capable of receiving satellite signals and of receiving and transmitting cellular signals.

In other embodiments the IOTAG does not rely on GPS, and instead the location information may be ascertained in other ways. For example, with control plane locating, the service provider gets the location based on the radio signal delay of the closest cell towers. GSM localization may also be used, in which the location of the IOTAG in relation to its cell site is determined. The service provider may rely on multilateration of the signal from cell sites serving the IOTAG. The geographical position of the IOTAG may be determined through various techniques like time difference of arrival (TDOA) or Enhanced Observed Time Difference (E-OTD). The location information in these configurations can include the transmissions from the IOTAG themselves, which may be used by the network to compute the time delay associated with the signal and hence the approximate distance from the IOTAG to the cell tower.

Another alternative is an operator- and GPS-independent location service based on access into the deep level telecoms network (SS7). This solution enables accurate and quick determination of geographical coordinates of mobile phone numbers by providing operator-independent location data and works also for handsets that are not GPS-enabled.

Network based techniques may include cell identification and triangulation, depending upon the degree of precision needed. When a cellular device is on, the network knows the device's location, which is triangulated from the cell towers nearby that record the device's signal. The location might be accurate to within a few meters in a densely populated area but only to a few hundred meters in a rural area with few cell towers.

One advantage of network-based techniques is that the circuitry of the IOTAG may be substantially simplified since no GPS receiver is required and since the network entity, rather than the IOTAG, would perform the major processing to determine location.

Handset-based techniques may include the installation of software on the IOTAG for determining its location. This technique provides location information of the IOTAG by cell identification and by assessing signal strengths of the home and neighboring cells. If the IOTAG is also equipped with GPS then significantly more precise location information can then be sent from the IOTAG to the carrier. Other location determination techniques may include SIM-based techniques and hybrid techniques. For the latter, location information may be determined by some combination of GPS and network based techniques.

In the event that source node 440 includes application software, e.g., as provided from the service provider concurrent with distributing the IOTAG(s), the application software may incorporate the location information into a user-friendly map for use by the subscriber in facilitating the location.

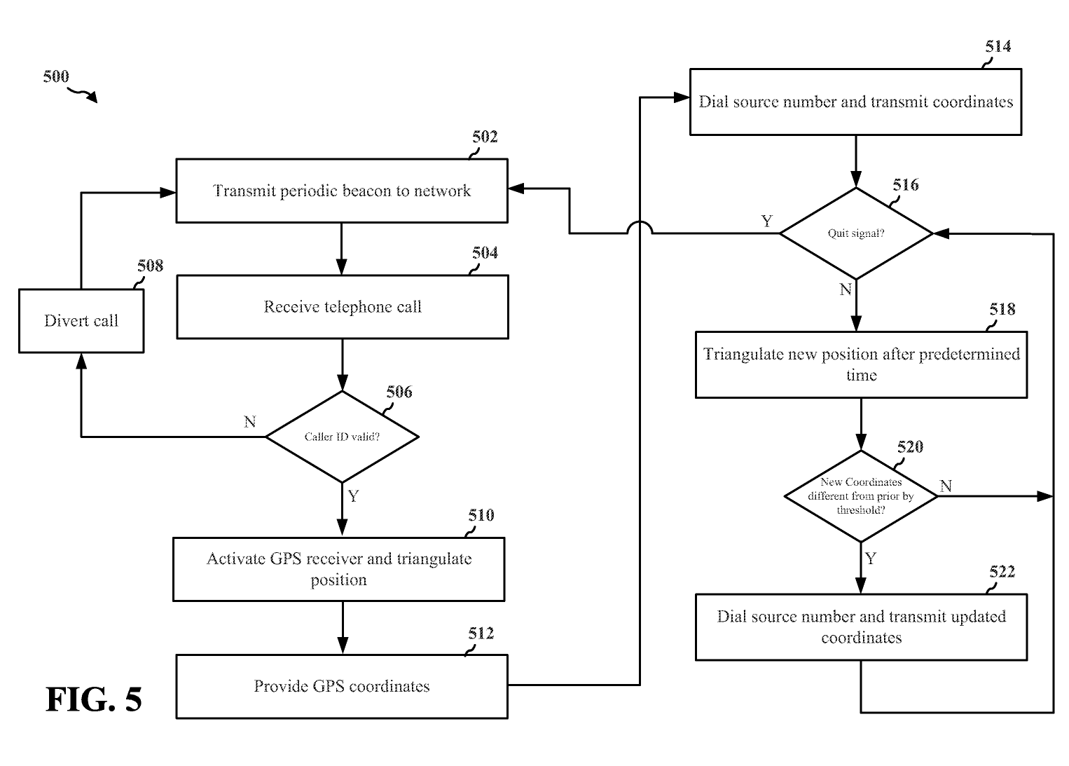

FIG. 5 is a flow diagram 500 of a method for locating objects. The IOTAG sends a period beacon or notification to the network with which it is registered, per the standards governing the particular network type (502). The IOTAG receives a telephone call, such as from the subscriber or the service provider (504). The IOTAG thereupon queries whether the caller identification is valid, i.e. it is from a recognized source such as from the subscriber (506). If not, the call is diverted (508) and the periodic beacons resume. If the call is recognized, the IOTAG activates its GPS receiver and triangulates its position using known techniques (510). Thereupon, the IOTAG provides coordinates indicative of location (512). The IOTAG dials the number of the subscriber and transmits the coordinates to the subscriber's location (514). In alternative embodiments as discussed above, the IOTAG may transfer the GPS coordinates or other location information to the service provider, which in turn performs any additional location calculations (where network-assisted location methods are used) and conveys the coordinates to the subscriber or to an application via the cellular network or the internet.

Upon transferring the GPS coordinates (and computing and transferring any updated coordinates after one or more respective time periods), the IOTAG determines whether it has received a message from the network to terminate the process and reset (516), in which case control returns to 502. If not, a new position is triangulated after a predetermined time (518) and, if the new coordinates differ from the prior coordinates by a threshold, suggesting that the object has moved or otherwise is not in substantially the same location (520), the IOTAG again dials the subscriber's number and transmits the updated coordinates over the cellular network (522) until a quit signal is received. In other embodiments, the IOTAG may provide updates for a prescribed number of attempts in lieu of using a quit signal, or in order to conserve power.

The integrated circuit as described herein may be powered in various ways depending on the application. Generally, the power requirements for the chip should be relatively low as the cell towers provide the majority of the energy connecting with the onboard cell receiver. Additionally, the satellites provide the majority of the signal strength to allow the coordinates to be calculated (provided that the requisite number of satellites is visible to the circuit).

In one embodiment, a battery is incorporated with the receiver and cell circuitry of the IOTAG as power supply 116 in FIG. 1. The battery may, for example, be disposed on a die adjacent that of the die containing the cell circuitry. Alternatively, the battery may form part of the casing, as discussed below. For various applications, however, the relatively big size (form factor) of a battery that would hold an adequate charge may be impractical for the types of applications for which the IOTAG can be suitable. Smaller size lithium ion batteries may also be utilized for more portable applications. However, the battery's energy may have been drained over time so as to render the receiver non-functional.

Accordingly, in one aspect of the disclosure, an apparatus for locating objects is disclosed which includes an integrated circuit powered by a Micro-Electro-Mechanical Systems (MEMS) device configured to harvest energy via movement of the device in which it is embedded. Today's MEMS technology allows relatively complex circuits to be fabricated into the integrated circuit, permitting functions such as accelerometers, gyros, and other capabilities readily available and found in most cellular handsets today. Using MEMS technology means that a small amount of energy or joules can activate the functions listed above without the additional size (form factor). One such device, implemented in 2011 by the Massachusetts Institute of Technology, was designed to generate energy from low-frequency vibrations including footsteps, automobile traffic, and swaying bridges. See, e.g., http://inhabitat.com/mit-unveils-tiny-kinetic-generator-that-produces-100-times-more-power-from-small-vibrations and http://newsoffice.mit.edu/2011/power-from-vibrations-0914. In addition, MicroGen Systems, Inc. produces MEMS-based Vibrational Energy Harvesting Micro Power Generators based on piezoelectric energy harvesting, used to power autonomous electronic devices. The devices began commercial-scale production in the summer of 2013.

Conventional MEMS circuits can extract energy from vibrations, thermal gradients, and light. The extracted energy may be stored on chip capacitors or rechargeable batteries. Harvested energy may come discontinuously in spurts. Accordingly, an efficient charger can be implanted to transfer energy to the capacitor or battery for use in powering the IOTAG.

Harvesting energy from mechanical movement such as vibrations has been effected using a spring mounted mass in a support frame. External vibrations, such as when the IOTAG is in motion, may cause the mass to oscillate. The oscillation of the mass produces an opposite damping force, which absorbs the energy from the movement of the mass. The resulting mechanical energy can be converted into electricity using, for example, an electrostatic element, a piezoelectric component or a magnet.

For example, one implementation may use a variable capacitor having plates that displace relative to one another based on vibrations. This implementation is compatible with integrated circuits, because MEMS capacitors may be fabricated on silicon.

Referring back to FIG. 1, apparatus 100 includes capacitor 118 for storing energy in the event that the power source is unable to produce electrical energy when the call is made. This may be the case, for example, when the object that has gone missing is at rest during a time that it needs to send a transmission to a network (e.g., to register with a cell) or during a time that it receives a call. Capacitor 118 is coupled to MEMS energy harvesting device and to the main circuit components of apparatus 100. Capacitor 118 may be disposed on the same die or, in alternative embodiments, on a separate die from other components of the integrated circuit. In short, kinetic energy produced by an on-chip MEMS as a power supply 116, combined with an on-chip capacitor storage device or small rechargeable battery, solve the anticipated power source problems for many applications and can be fabricated at a very low cost and virtually no additional form factor or size issues.

In another aspect of the disclosure, power supply 116 includes a circuit for harvesting solar energy which is coupled to one or more solar cells. The cells may be disposed on an external surface of the packing of the integrated circuit. The use of a solar cell is generally a low cost option and requires a minimal form factor. This embodiment may be employed in environments where the item to be tracked is likely to be outdoors and exposed to sunlight. One disadvantage of this approach, depending on the application, is that the IOTAG may be sheltered from the sunlight or it may be dark when the circuit is to be activated. Thus, in an alternative embodiment, capacitor 118 or a small, rechargeable lithium ion battery may be employed with the solar cell to enable the device to function in applications where the solar cells are not exposed to the sunlight.

In other embodiments, the IOTAG may use the power supply, if available and such use is suitable in view of the application, of the object to be located. The advantage of this method of power sourcing is that it comes for free with the device being tagged. For example, an IOTAG attached to a vehicle can include a pair of terminals used to power the integrated circuit with the vehicle's 12 volt battery.

Alternatively, one or more thermocouple devices may be used to source power to the IOTAG. Thermocouple devices have no moving parts but require a heat source such as a radioisotope or other source of heat to activate the circuit. As an illustration, a circuit embedded in a diaper may be activated by the heat of the urine versus a dry diaper.

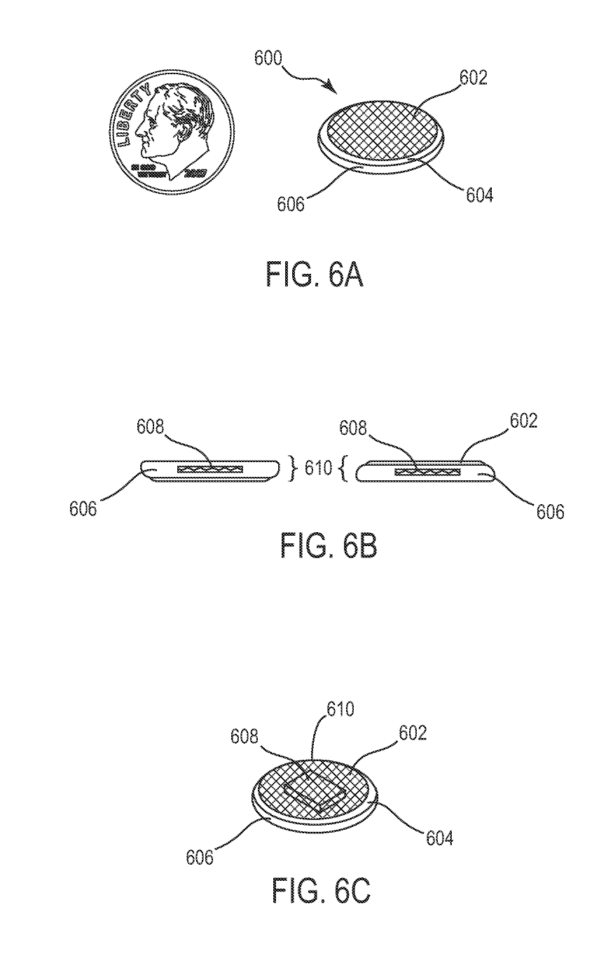

FIG. 6A is an illustration of an exemplary apparatus 600 for locating objects. In the configuration shown, the apparatus 600 is approximately the size of a dime. While the shape of the apparatus 600 is cylindrical in this embodiment, other shapes such as a cubical or trapezoidal shape may equally be contemplated. The apparatus contains a housing including outer surface 604 and side wall 606. The outer surface may be comprised of a typical chip epoxy covering for protecting the chip from humidity and other elements. The apparatus includes an adhesive layer 602, which may further include a protective cover that can be peeled off before use. The adhesive layer 602 enables a person to affix the apparatus to an object. In other embodiments, a mounting fixture may be used, which may include a clamp, mount, or similar structure.

FIG. 6B illustrates side views of the apparatus 600 of FIG. 6A. The side views are shown as transparent so as to illustrate a cross sectional view of integrated circuit 608 disposed within the housing 610.

FIG. 6C illustrates a perspective view of the device showing integrated circuit 608 embedded within the device, outer surface 604 of housing 610, side wall 606 of housing 610, and adhesive 602.

Housing 610 may in some embodiments include the packaging of integrated circuit 608. In other embodiments, the die may be contained on a separate package contained on, or embedded within, housing 610. In still other configurations, housing 610 is not fully closed, and integrated circuit 608 is disposed on one side of housing 610 or otherwise secured to housing 610. From the packaging of integrated circuit 608, one or more leads may be extended to a portion of the housing, in some implementations, for supplying power or other signals to and from integrated circuit 608. In addition, an antenna may be disposed about a portion or all of the perimeter of the housing of integrated circuit 608 and routed and electrically coupled to designated input/output pads on integrated circuit 608. For example, with reference to FIG. 6C, an antenna may extend around part or all the circumference of the circle defined by side wall 606. In other embodiments, the antenna may be disposed on a surface 604 of the housing.

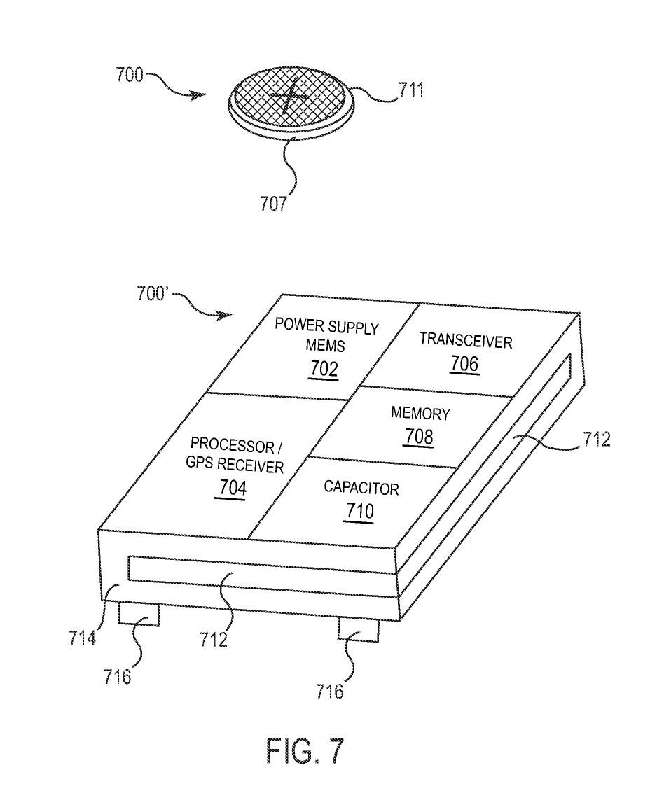

FIG. 7 illustrates a perspective view of apparatus 700 and integrated circuit 700′, and an exemplary layout of functional blocks therein. In the embodiment shown by apparatus 700, terminals from integrated circuit extend internally within apparatus 700 to an upper and a lower surface of housing 711. Each outer surface may include a conducting material, and side wall 707 is at least partially an insulator. Other portions of side wall 707 may include one or more antennas disposed about the perimeter. In this embodiment, apparatus 700 may be charged by inserting it into a suitable external power source. Alternatively, apparatus 700 may contain a miniature rechargeable battery, which may be charged by inserting apparatus 700 into the power source.

The die 714 of integrated circuit 700′ is embedded may be embedded in an IC package, which may be embedded in or affixed to a separate housing such as housing 711. Included as part of the die are processor/GPS receiver 704, which processes the cellular and GPS signals; transceiver 706 for sending and receiving data over the cellular network and for receiving GPS signals for processing by GPS receiver 704; memory 708 for storing information, applications and subscriber identity information; power supply 702 for providing a power source to the circuit, which in one embodiment includes a MEMS device for harvesting vibrations and other mechanical energy for use as electrical power; and capacitor 710 for storing electrical energy for use in powering the integrated circuit 700′ when power supply 702 is unable to produce a charge by itself.

Package 714 may include one or more terminals 712, which include one or more antennas that extend from the IC die as noted above and out to the housing. Package 714 may further include leads 716 (shown at the base of die 714 for simplicity) for supplying power to integrated circuit 700′, either from a power source internal to housing 711 or from an external power source.

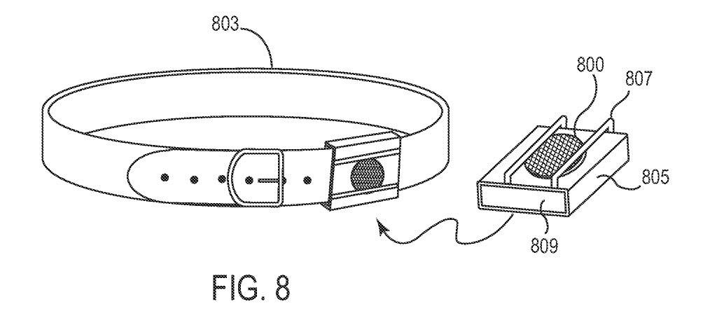

FIG. 8 is an illustration of an apparatus 800 for locating objects affixed to a pet collar 803 via a clamp mechanism 805. Apparatus 800 is secured in clamp mechanism 805 by bands 807 which may constitute any suitable material and may extend across a surface of clamp mechanism 805. Clamp mechanism 805 includes opening 809 through which collar 803 may be routed to secure clamp mechanism with the IOTAG onto collar 803.

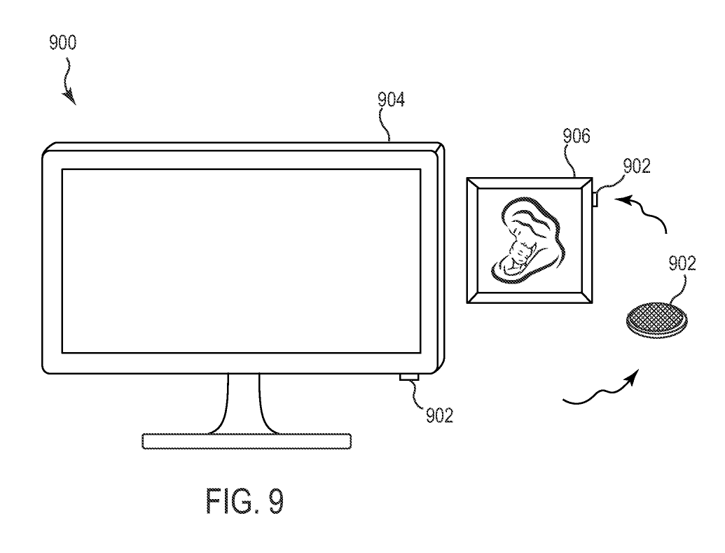

FIG. 9 is an illustration 900 of an IOTAG 902 affixed to the underside of a computer monitor 904 and to a painting 906. Preferably, IOTAG 902 is small enough to be inconspicuous. In one embodiment, IOTAG 902 may be inserted underneath the frame of painting 906, or inside a vase, or into an otherwise inconspicuous location of an object where the application is to monitor objects in light of a potential theft.

It is understood that the specific order or hierarchy of blocks in the processes/flow charts disclosed is an illustration of exemplary approaches. Based upon design preferences, it is understood that the specific order or hierarchy of blocks in the processes/flow charts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. An apparatus, comprising:
a housing; and
an integrated circuit arranged in the housing, the integrated circuit comprising:
a transceiver configured to receive, over a cellular network, a notification for tracking an object to which the housing is operatively affixed; and
a processor coupled to the transceiver and configured to determine, responsive to the notification, information characterizing a location of the object, wherein the transceiver is further configured to transmit the information over the cellular network to a source node.

2. The apparatus of claim 1, further comprising a mounting fixture,
wherein the mounting fixture is attached to an outer surface of the housing and configured to enable fixture of the integrated circuit onto the object.

3. The apparatus of claim 1, further comprising an adhesive,
wherein the adhesive is attached to an outer surface of the housing and configured to enable fixture of the integrated circuit onto the object.

4. The apparatus of claim 1, wherein the integrated circuit further comprises a memory having an identification code stored therein, the identification code comprising an identifier for enabling the notification over the cellular network.

5. The apparatus of claim 4, wherein the identification code comprises a telephone number.

6. The apparatus of claim 1, wherein the notification comprises a voice call.

7. The apparatus of claim 1, wherein the notification comprises a text message.

8. The apparatus of claim 1, wherein the notification comprises a page.

9. The apparatus of claim 1, wherein the cellular network comprises at least one of a 2G, 3G, 3.5G, and 4G network.

10. The apparatus of claim 1, wherein the information transmitted to the source node is routed through a network entity.

11. The apparatus of claim 1, wherein the information comprises Global Positioning System (GPS) coordinates.

12. The apparatus of claim 1, wherein the integrated circuit further comprises a Global Positioning System (GPS) receiver.

13. The apparatus of claim 12, wherein the processor comprises a component of the GPS receiver.

14. The apparatus of claim 1, wherein the integrated circuit comprises at least one antenna disposed around at least a portion of a perimeter of the housing.

15. The apparatus of claim 14, wherein the at least one antenna is configured to receive cellular data and Global Positioning System (GPS) data.

16. The apparatus of claim 1, further comprising a power source.

17. The apparatus of claim 16, wherein the power source comprises a component of the integrated circuit.

18. The apparatus of claim 16, wherein the power source comprises a Micro-Electro-Mechanical Systems (MEMS) device configured to harvest kinetic energy from mechanical movement or vibrations.

19. The apparatus of claim 16, wherein the power source comprises a battery.

20. The apparatus of claim 16, wherein the power source comprises at least one solar cell configured to harvest energy from light.

21. The apparatus of claim 16, wherein the power source comprises a thermocouple device configured to harvest energy from heat.

22. The apparatus of claim 1, wherein the integrated circuit is coupled to a power supply of the object and is configured to use the power supply of the object as a power source.

23. The apparatus of claim 18, wherein the power source further comprises at least one an on-chip capacitor configured to provide power to the integrated circuit when the MEMS device is unable to generate power.

24. The apparatus of claim 20, wherein the power source further comprises at least one an on-chip capacitor configured to provide power to the integrated circuit when the at least one solar cell is unable to generate power.

25. The apparatus of claim 21, wherein the power source further comprises at least one an on-chip capacitor configured to provide power to the integrated circuit when the thermocouple device is unable to generate power.

26. The apparatus of claim 1, wherein:
the transceiver is configured to send and receive data over a WiFi network; and
the processor is further configured to
identify, via data received from the transceiver, an available WiFi network; and
connect to the available WiFi network,
wherein the transceiver is further configured to transmit the information over the WiFi network to the source node.

27. An apparatus, comprising:
an integrated circuit;
a housing encasing at least a portion of the integrated circuit therein, an outer surface of the housing affixed via an attachment medium to an object, wherein the integrated circuit comprises:
a transceiver configured to receive, over a cellular network, a notification; and
a processor coupled to the transceiver and configured to provide, after receiving the notification, information characterizing a location of the object, wherein the transceiver is further configured to transmit the information to a source node for use in locating the object.

28. The apparatus of claim 27, wherein the integrated circuit further comprises a memory having a telephone number stored therein.

29. The apparatus of claim 27, wherein the information transmitted to the source node is routed through a network entity.

30. The apparatus of claim 27, wherein the integrated circuit further comprises a Global Positioning System (GPS) receiver.

31. The apparatus of claim 30, wherein the processor comprises a component of the GPS receiver.

32. The apparatus of claim 27, further comprising a power source, the power source comprising a Micro-Electro-Mechanical Systems (MEMS) device configured to harvest kinetic energy from mechanical movement.

33. The apparatus of claim 32, wherein the power source comprises a component within the integrated circuit.

34. The apparatus of claim 32, wherein the power source further comprises at least one an on-chip capacitor configured to provide power to the integrated circuit when the MEMS device is unable to generate power.

35. An integrated circuit device, comprising:
an integrated circuit; and
a packaging substantially encasing the integrated circuit, an external surface of the packaging operatively affixed via an attachment medium to an object to be monitored,
wherein the integrated circuit comprises a processing system configured to:
receive a notification over a cellular network;
provide, responsive to the notification, information for identifying a location of the object;
dial a telephone number associated with a source node; and
transmit the information over the cellular network to the source node, wherein the integrated circuit further comprises a power source comprising a Micro-Electro-Mechanical Systems (MEMS) device configured to harvest kinetic energy from mechanical movement.

36. The integrated circuit of claim 35, further comprising a Global Positioning System (GPS) receiver.
